(19) United States
(12) Patent Application Publication
(10) Pub. No.: US 2010/0081595 A1
(43) Pub. Date: Apr. 1, 2010

(54) LIQUID CLEANING COMPOSITION AND METHOD FOR CLEANING SEMICONDUCTOR DEVICES

(75) Inventor: Balgovind Sharma, Fishkill, NY (US)

Correspondence Address: LARSON NEWMAN & ABEL, LLP, 5914 WEST COURTYARD DRIVE, SUITE 200, AUSTIN, TX, 78730, US

(73) Assignee: Freescale Semiconductor, Inc, Austin, TX (US)

(21) Appl. No.: 12/523,930

(22) PCT Filed: Jan. 22, 2007
(86) PCT No.: PCT/IB07/50203

§ 371 Date: Jul. 21, 2009

(51) Int. Cl. C11D 3/28; C11D 3/20

(52) U.S. Cl. 510/175

(57) ABSTRACT

Aqueous liquid cleaning composition for wet cleaning of the sidewalls and bottom of vias formed in a dielectric layer of a semiconductor device, said composition comprising: c) hydrofluoric acid; d) a corrosion inhibitor which is a polyazo corrosion inhibitor or carboxylic acid corrosion inhibitor.

Integrated circuits generally contain a number of interconnect layers consisting of conductive and isolating materials. In the interconnects, there may be “trenches” (substantially horizontal with respect to the superimposed layers of the semiconductor substrate, and which are then filled with metallic conducting material) and “vias” (plugs enabling vertical communication between layers when filled with metallic conducting material). Many techniques have been developed to enable the laying of trenches or filling of vias so as to have precisely defined patterns. For example, the trench bottom and sidewall may be coated with a barrier layer in order inter alia to prevent diffusion of metal atoms from the metallic trench into the surrounding dielectric and semiconducting layer.

The precise pattern of trenches and vias in an integrated circuit layer is defined by a photolithographic etching process. A given layer of the semiconductor substrate is covered with a material known as a “photoresist”. Using a mask, particular regions only of this photoresist layer, according to a pre-defined circuit pattern, are irradiated. In common “positive” photoresists, the photoresist is an organic polymer which is transformed by UV radiation to give products soluble in alkaline solution.

Once the photoresist layer has been exposed to UV light and the exposed areas removed, it is possible to etch trenches and vias in the now exposed underlying areas, the surrounding areas being shielded by the remaining photoresist, this covering persisting in areas not irradiated. Plasma-based systems are usually used to etch the exposed semiconductor material. For example, fluorine atom or chlorine atom-containing plasmas may be used to etch dielectric layers. In such a system, the reaction products (such as silicon tetrafluoride) are removed as gases. In modern methods of etching, both physical and chemical effects are combined i.e. reactive ions are fired at semiconductor surfaces to displace atoms by a physical process, and the same ions, or other ions in a multi-component plasma, react with (silicon) surface atoms to produce new chemical species.

After etching, it is necessary to remove the photoresist which protected the parts of the semiconductor layer which were not to be etched. A typical process for this uses an oxygen-based plasma, in a plasma treatment step separate from that used to etch the semiconductor layer. This treatment step is called “ashing”.

However, the etching process does not in practice leave perfectly defined trenches and/or vias in the dielectric material with a perfectly pure chemical boundary i.e. with walls whose outer layer consists only of the semiconductor material being etched. Residues are left due to combination, during the etching process, of materials in the plasma with surface materials, including photoresist polymers, exposed metals or nitride interlayers during via fabrication etc. The residues may contain a number of chemical elements (C, O, F, Si, Cu, H and N) and are often of mixed and indeterminate natures.

There exists therefore a need in the art to remove, at the post-etching stage, not only the top layer of non-irradiated photoresist, but also species laid down around the etched trench or via.

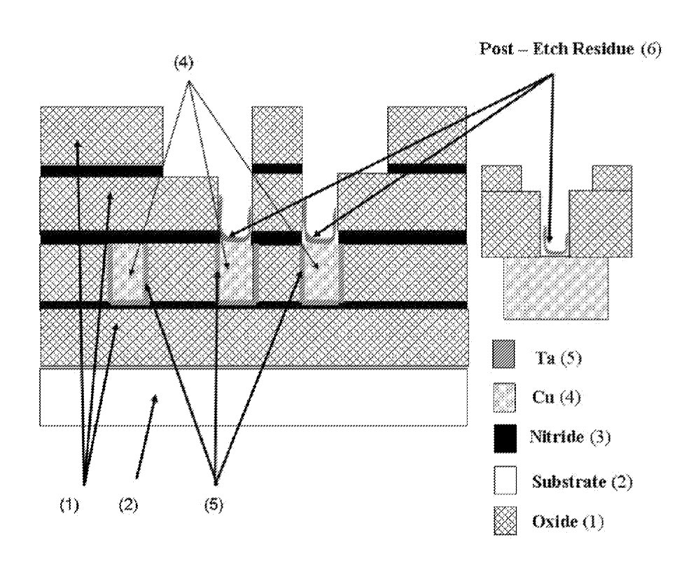

An illustrative but non-limitative example of the type of situation encountered is shown in FIG. 1. An etching step has exposed not only a top layer but also an underlying layer and in particular an etched void which is to become a via (a vertical conducting connection). In such a system, layers of oxide (1) separated by nitride (3) are built up on a substrate (2). The copper (4) is not in direct contact with oxide (1), or with nitride (3) on the upper side of the trenches, on account of the Ta barrier (5). As illustrated, post-etch residues (6) may remain on the sidewalls and bottom above the etched void which is to become a via.

In this type of situation, it is necessary to remove the via bottom and sidewall residues without damaging underlying metal and dielectric.

Existing cleaning solutions known in the semiconductor industry do not enable both effective cleaning and reduced damage to underlying metal and dielectric.

A particular area of current interest is the area of inlaid (in other words, damascene) technology with copper interconnects. In typical damascene technology, an oxide interlevel dielectric is patterned by photoresist and then etched to expose the underlying layers. After photoresist stripping and via cleaning, a barrier layer is used to line the thus created via wall and bottom, and then a metallic layer is inlaid. Finally, the excess metal (and barrier material if this overflows the via walls) are removed by chemical-mechical polishing (CMP). The top of the metal-filled via is thus made to be a smooth continuation of the top of the flat oxide layer. Of particular interest at the present time is damascene technology with copper interconnects (rather than aluminium or tungsten interconnects, as are also known). Barrier layers, which are laid down in vias before filling with metal, are designed to prevent diffusion of metal atoms through surrounding dielectrics into the silicon substrate. The barrier layer should adhere to the oxide and at the same time the specific microscopic structure of the barrier layer i.e. its regularity, has an effect on determining the structure profile of the metal layer laid down subsequently. For copper-inlaid systems, barriers based on tantalum (Ta) and tantalum nitride (TaN) have attracted particular interest.

The present invention provides a cleaning solution and method for using the cleaning solution to remove post-etch residues as described in the accompanying claims.

It is envisaged in the present invention that the cleaning solution be substantially or fully aqueous. It is envisaged that non-aqueous solvents could be combined with water.

In one embodiment according to the present invention, the concentration of hydrofluoric acid in the liquid composition obtained by mixing aqueous hydrofluoric acid with a corrosion inhibitor is suitably chosen in the range of 0.001 to 0.1 wt %.

It is possible to add the two components, i.e. (a) HF, and (b) corrosion inhibitor, separately, rather than mixing them and then applying a single solution to the semiconductor device to be cleaned. Separate sources of each of the two components may be used to supply each of the two components separately to the cleaning tool. A further possibility is to increase the concentration of the corrosion inhibitor at the end of the process step to provide better passivation.

In one embodiment according to the present invention, the concentration of corrosion inhibitor in the liquid composition obtained by mixing aqueous hydrofluoric acid with a corrosion inhibitor is suitably chosen in the range of 0.0001 to 1 wt %.

According to one embodiment of the present invention, a particularly suitable corrosion inhibitor used in combination with hydrofluoric acid is the polyazo corrosion inhibitor benzotriazole, which has the following chemical structure:

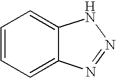

According to a further embodiment of the present invention, the corrosion inhibitor used in combination with hydrofluoric acid is the polyazo corrosion inhibitor 1,2,4-triazole, which has the following chemical structure:

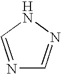

According to a further embodiment of the present invention, the corrosion inhibitor used in combination with hydrofluoric acid is the polyazo corrosion inhibitor bipyridine (2,2′-bipyridine), which has the following chemical structure:

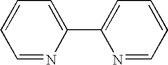

According to a further embodiment of the present invention, the corrosion inhibitor used in combination with hydrofluoric acid is the polyazo corrosion inhibitor imidazole, which has the following chemical structure:

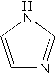

Is it possible to use combinations of the above-cited polyazo corrosion inhibitors in the framework of the present invention. It may be appropriate to do so in order to benefit from improved efficiency of some inhibitors for Cu(I) species with respect to other Cu species, and improved efficiency of other inhibitors for Cu(II) or metallic copper.

According to a further embodiment of the present invention, the corrosion inhibitor used in combination with hydrofluoric acid is the carboxylic acid corrosion inhibitor phthalic acid, which has the following chemical structure:

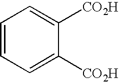

According to a further embodiment of the present invention, the corrosion inhibitor used in combination with hydrofluoric acid is the carboxylic acid corrosion inhibitor malic acid, which has the following chemical structure:

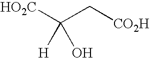

According to a further embodiment of the present invention, the corrosion inhibitor used in combination with hydrofluoric acid is the carboxylic acid corrosion inhibitor malonic acid, which has the following chemical structure:

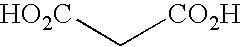

According to a further embodiment of the present invention, the corrosion inhibitor used in combination with hydrofluoric acid is the carboxylic acid corrosion inhibitor glycolic acid, which has the following chemical structure:

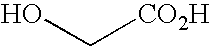

Is it possible to use combinations of the above-cited carboxylic acid corrosion inhibitors in the framework of the present invention.

According to one embodiment of the cleaning method of the present invention, the semiconductor device cleaned is of the damascene type with copper interconnects and tantalum-based barriers. The barrier material may in particular be based on tantalum (Ta) or tantalum nitride (TaN).

According to a further embodiment of the cleaning method of the present invention, the dielectric layer may comprise silicon dioxide (SiO₂) or carbonated silicon dioxide (SiOC).

The dielectric layer of the semiconductor device cleaned in the present invention may be porous or non-porous.

The dielectric layer may in particular be a low dielectric constant (k) or ultra-low (k) material selected from the group consisting of: polyimides, poly(arylene)ethers, poly(arylene) ether azoles, parylene-N, polynaphthalene-N, polyphenylquinoxalines (PPQ), polyphenyleneoxide, polyethylene, polypropylene, silicon-carbon-oxygen-hydrogen (SiCOH) organic dielectrics, carbon-doped silicon oxide, porous methyl silsesquioxane, nanoporous silica, fluorine-doped silicon dioxide.

The semiconductor device which may be cleaned according to the present invention may have been etched following coating by a photoresist belonging to any of the commercially available groups of photoresists. In positive photoresists, photolysis of the photoresist material generates a new chemical species (an acid group) which is soluble in alkaline solution. Typical positive photoresists include novolak-based photoresists. It is expected that the cleaning solutions of the present invention may also be used in contexts where negative photoresists have been used.

According to a further embodiment, subsequent to the etching process, the top layer of photoresist is removed by a plasma ashing step, before wet cleaning is commenced by application of the liquid cleaning composition according to the invention.

When applying the method of the present invention for cleaning the sidewalls and bottom of vias formed in a dielectric layer of a semiconductor device the flow of liquid cleaning composition can appropriately be controlled by flow controllers and the individual semiconductor devices (wafers) to be cleaned are typically rotated. Alternatively, “batch tools” can be also used where wafers are immersed to the solution. The temperature range of cleaning is appropriately selected within the range of 20° C. to 90° C. The duration of the cleaning process is appropriately from 30 s to 5 min when single wafers are used, and from 1 min to 1 h for batch tool processes. Techniques such as ultrasonic or megasonic techniques can be used to accelerate liquid-solid interaction during the cleaning process, but it will generally not be appropriate to use photo-radiation in this context since substrates to be cleaned may show sensitivity to photocorrosion. After treatment with the liquid cleaning composition, (transformed) post-etch residues may also, where not dissolved and/or washed away in the liquid cleaning process, be at least in part removed by a “lift-off” process, in which a layer under the surface layer is dissolved or rendered fragile enabling “lift-off” of higher layers.

The present invention provides technical advantages not obtainable with prior art compositions and in particular, there is a reduction in the problem of degradation of underlying metal and/or dielectrics resulting in yield loss and poor electrical performance. The cleaning composition and method of the present invention is suitable for low k and porous low k structures. In addition, the composition, in particular the compositions containing only the two components of hydrofluoric acid+a corrosion inhibitor, are easy to prepare and use.

1. Aqueous liquid cleaning composition for wet cleaning of the sidewalls and bottom of vias formed in a dielectric layer of a semiconductor device, said composition comprising:
a) hydrofluoric acid;
b) a corrosion inhibitor which is a polyazo corrosion inhibitor or carboxylic acid corrosion inhibitor.

2. Composition according to claim 1, wherein the hydrofluoric acid is present in an amount of 0.001 to 0.1 weight % with respect to the total weight of the composition.

3. Composition according to claim 1, wherein the corrosion inhibitor is present in an amount of 0.0001 to 1 weight % with respect to the total weight of the composition.

4. Composition according to claim 1, wherein the polyazo corrosion inhibitor is selected from the group consisting of: benzotriazole; 1,2,4-triazole; bipyridine; imidazole.

5. Composition according to claim 1, wherein the carboxylic corrosion inhibitor is selected from the group consisting of: phthalic acid; malic acid; malonic acid; glycolic acid.

6. Composition according to claim 1, which consists essentially of a) an aqueous solution of hydrofluoric acid and b) a corrosion inhibitor chosen from the group consisting of: polyazo corrosion inhibitors and carboxylic acid corrosion inhibitors.

7. Composition according to claim 1, which consists of a) an aqueous solution of hydrofluoric acid and b) a corrosion inhibitor chosen from the group consisting of: polyazo corrosion inhibitors and carboxylic acid corrosion inhibitors.

8. Method for cleaning the sidewalls and bottom of vias formed in a dielectric layer of a semiconductor device comprising the steps of:
applying a liquid cleaning composition to a semiconductor device with post-etch residues, wherein the liquid cleaning composition comprises hydrofluoric acid and a corrosion inhibitor which is a polyazo corrosion inhibitor or carboxylic acid corrosion inhibitor;
allowing the liquid cleaning composition to act to transform and/or remove post-etch residues from the sidewalls and bottom of vias at a temperature of from 20° C. to 90° C.;
removing the liquid cleaning composition and transformed and/or removed post-etch residues.

9. Method according to claim 8, wherein the semiconductor device is of the damascene type with copper interconnects and tantalum-based barriers.

10. Method according to claim 8, wherein the dielectric layer comprises silicon dioxide (SiO₂) or carbonated silicon dioxide (SiOC).

11. Method according to claim 8, wherein the dielectric layer is porous or non-porous.

12. Method according to claim 8, wherein the dielectric layer is a low dielectric constant (k) or ultra-low (k) material selected from the group consisting of: polyimides, poly(arylene)ethers, poly(arylene) ether azoles, parylene-N, polynaphthalene-N, polyphenylquinoxalines (PPQ), polyphenyleneoxide, polyethylene, polypropylene, silicon-carbon-oxygen-hydrogen (SiCOH) organic dielectrics, carbon-doped silicon oxide, porous methyl silsesquioxane, nanoporous silica, fluorine-doped silicon dioxide.

13. Method according to claim 8, wherein, subsequent to the etching process, the top layer of photoresist is removed by a plasma ashing step, before wet cleaning is commenced by application of the liquid cleaning composition.

14. A method comprising:
using a liquid cleaning composition in the cleaning of the sidewalls and bottom of vias formed in a dielectric layer of a semiconductor device by removal of post-etch residues, wherein the liquid cleaning composition comprises hydrofluoric acid and a corrosion inhibitor which is a polyazo corrosion inhibitor or carboxylic acid corrosion inhibitor.

15. Method according to claim 9, wherein the dielectric layer comprises silicon dioxide (SiO₂) or carbonated silicon dioxide (SiOC).

16. Method according to claim 9, wherein the dielectric layer is a low dielectric constant (k) or ultra-low (k) material selected from the group consisting of: polyimides, poly(arylene)ethers, poly(arylene) ether azoles, parylene-N, polynaphthalene-N, polyphenylquinoxalines (PPQ), polyphenyleneoxide, polyethylene, polypropylene, silicon-carbon-oxygen-hydrogen (SiCOH) organic dielectrics, carbon-doped silicon oxide, porous methyl silsesquioxane, nanoporous silica, fluorine-doped silicon dioxide.

17. Method according to claim 10, wherein the dielectric layer is a low dielectric constant (k) or ultra-low (k) material selected from the group consisting of: polyimides, poly(arylene)ethers, poly(arylene) ether azoles, parylene-N, polynaphthalene-N, polyphenylquinoxalines (PPQ), polyphenyleneoxide, polyethylene, polypropylene, silicon-carbon-oxygen-hydrogen (SiCOH) organic dielectrics, carbon-doped silicon oxide, porous methyl silsesquioxane, nanoporous silica, fluorine-doped silicon dioxide.

18. Method according to claim 9, wherein, subsequent to the etching process, the top layer of photoresist is removed by a plasma ashing step, before wet cleaning is commenced by application of the liquid cleaning composition.

19. Method according to claim 10, wherein, subsequent to the etching process, the top layer of photoresist is removed by a plasma ashing step, before wet cleaning is commenced by application of the liquid cleaning composition.

20. Composition according to claim 2, wherein the corrosion inhibitor is present in an amount of 0.0001 to 1 weight % with respect to the total weight of the composition.
